(19) United States
(12) Patent Application Publication
(10) Pub. No.: US 2011/0132930 A1
(43) Pub. Date: Jun. 9, 2011

(54) TOILETRIES DISPENSING DEVICE AND METHOD FOR REPLACING A PLURALITY OF DISPENSING BOTTLES

(76) Inventor: Kenneth R. Haworth, Walnut Creek, CA (US)

(21) Appl. No.: 12/960,338

(22) Filed: Dec. 3, 2010

Related U.S. Application Data
(60) Provisional application No. 61/266,446, filed on Dec. 3, 2009.

(51) Int. Cl. B67D 7/84; B67D 7/06; B23P 11/00; B05C 17/005

(52) U.S. Cl. 222/135; 222/153.01; 222/180; 29/428

(57) ABSTRACT

The present invention is a toiletries dispensing device with a back plate that supports a non-evasive means for mounting the toiletries dispensing device on a wall or other vertical mounting surface, a plurality of dispensing bottles with a pump disposed on top of each dispensing bottle to dispense toiletries as desired by a user, a flange assembly with a top surface and a removable section with a plurality of attachment tabs, a stationary section with a plurality of receiving slots and a plurality of pump apertures that hold and secure the dispensing bottles. There is also a mountable lock to lock the dispensing bottles in place and a bottom support surface with a smooth surfacing that the dispensing bottles are set on. There is also a method for replacing the dispensing bottles as well.

This application claims priority to U.S. Provisional Application 61/266,446 filed on Dec. 3, 2009, the entire disclosure of which is incorporated by reference.

### TECHNICAL FIELD & BACKGROUND

The present invention generally relates to a dispensing device. More specifically, the invention is a toiletries dispensing device and a method for replacing a plurality of dispensing bottles in a toiletries dispensing device.

It is an object of the invention to provide a toiletries dispensing device for a lockable tamper resistant way to provide shower and bath amenities and toiletries to users of shower and bath facilities.

It is an object of the invention to provide a toiletries dispensing device with a lockable mount that uniquely allows for pumps from a plurality of dispensing bottles to extend through a top flange of the toiletries station device, keeping the bottles unexposed to tampering, but still leaving a large area on the bottles for branding and an opportunity to change the dispensing bottles' color, style and aesthetic appearance.

It is an object of the invention to provide a toiletries dispensing device that has a smooth back plate that can be mounted without damage to any vertical mounting surface by utilizing double sided tape or other non-evasive means for mounting the toiletries dispensing device.

It is an object of the invention to provide a toiletries dispensing device that has a mountable lock that keeps a plurality of dispensing bottles in place while allowing only authorized persons access to the dispensing bottles.

What is needed is a toiletries dispensing device and a method for replacing dispensing bottles in a toiletries dispensing device that includes a lockable tamper resistant way to provide shower and bath amenities to users of shower and bath facilities, a lockable mount that uniquely allows for pumps from a plurality of dispensing bottles to extend through a top flange of the toiletries station device, keeping the dispensing bottles unexposed to tampering, but still leaving a large area on the dispensing bottles for branding and opportunity to change the dispensing bottles' color, style and aesthetic appearance, that has a smooth back plate that can be mounted without damage to tile work on any bathroom surface by utilizing double sided tape instead of screws and that has a mountable lock that keeps the plurality of dispensing bottles in place while allowing only authorized persons access to the dispensing bottles.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a front side perspective view of a toiletries dispensing device, in accordance with one embodiment of the present invention.

FIG. 1B illustrates a tilted front side perspective view of a toiletries dispensing device without dispensing bottles, in accordance with one embodiment of the present invention.

FIG. 1C illustrates a rear side perspective view of a toiletries dispensing device without dispensing bottles, in accordance with one embodiment of the present invention.

FIG. 1D illustrates an exploded overhead perspective view of a toiletries dispensing device without dispensing bottles and flange assembly, in accordance with one embodiment of the present invention.

FIGS. 2A and 2B illustrate a flow chart of a method for replacing dispensing bottles in a toiletries dispensing device, in accordance with one embodiment of the present invention.

FIG. 3 illustrates a perspective view of a pin stud, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

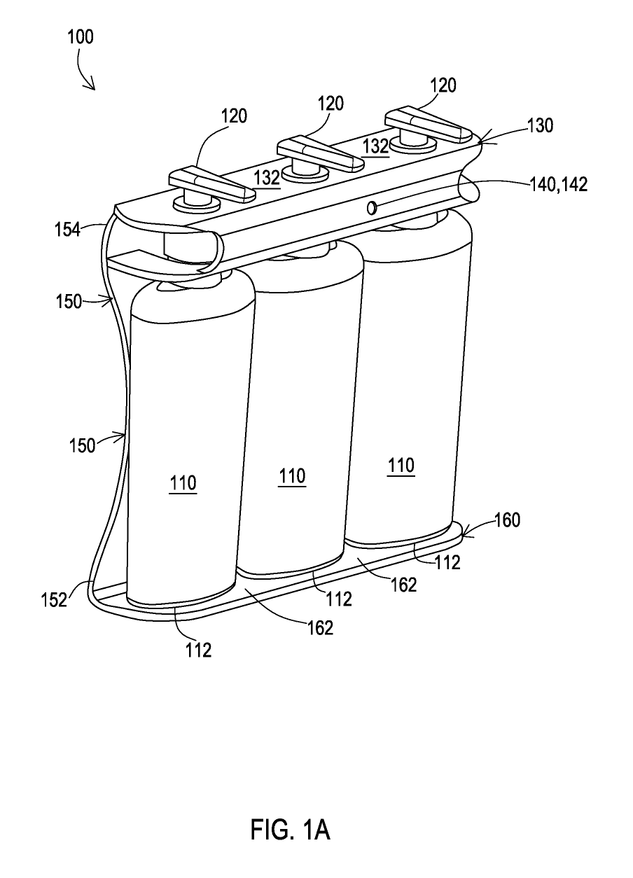

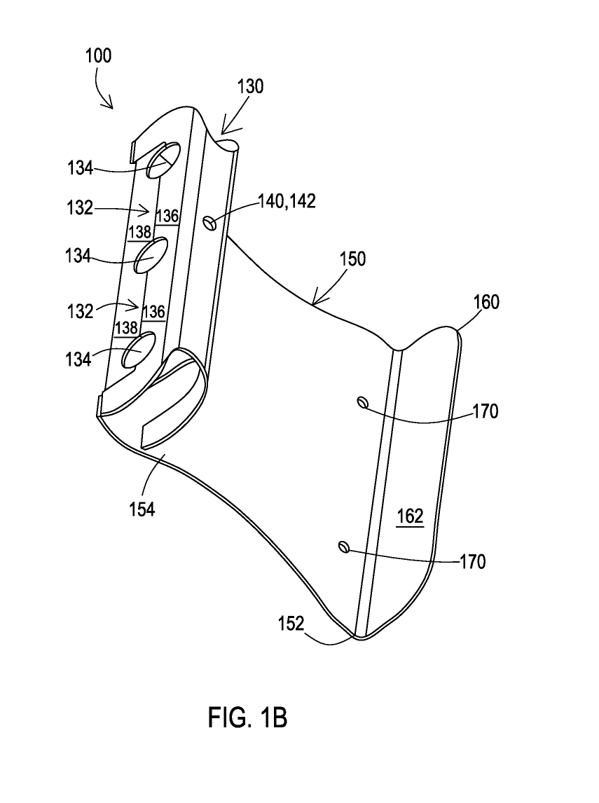

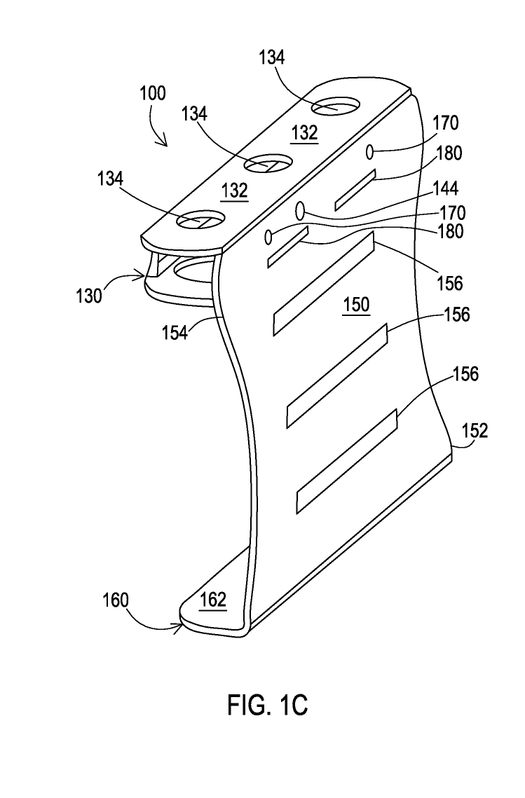

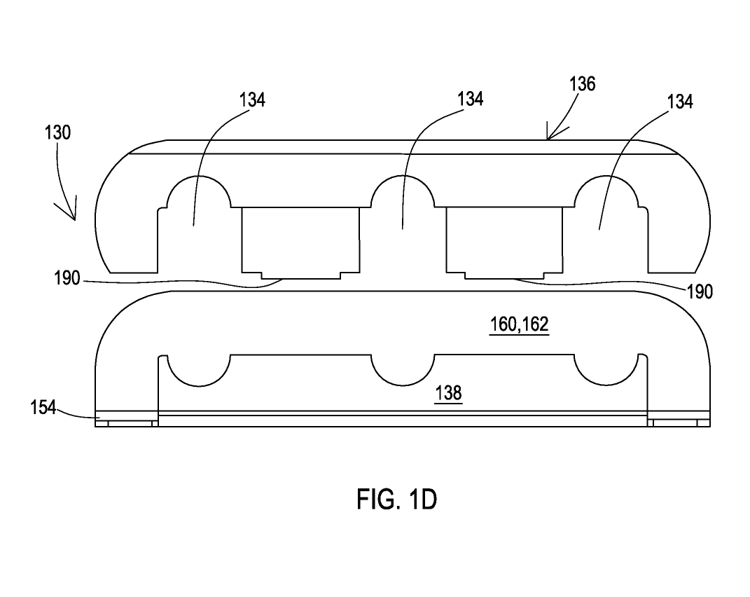

FIG. 1A illustrates a front side perspective view of a toiletries dispensing device 100, in accordance with one embodiment of the present invention. The toiletries dispensing device 100 provides a lockable tamper resistant way to provide shower and bath amenities and toiletries in a plurality of dispensing bottles 110 to users of shower and bath facilities. The plurality of dispensing bottles 110 can be any number of dispensing bottles that are well known in the art that can be accommodated by the toiletries dispensing device 100, although three dispensing bottles 110 are illustrated in FIG. 1A. The toiletries dispensing device 100 can be utilized in the shower and bathroom facilities at any location, such as a hotel, a motel, a locker room or other location that is well known in the art. Each dispensing bottle 110 has a pump 120 that extends through a flange assembly 130 and a mountable lock 140 disposed on the top of the toiletries dispensing device 100. The mountable lock 140 keeps the dispensing bottles 110 in place while allowing only authorized person's access to the dispensing bottles 110. A pin stud 142 is provided and mates and engages with a pin stub aperture 144 disposed on the back plate 150 forming a secure attachment of the removable section of the flange assembly 136 with the stationary section of the flange assembly 138, as described in the FIGS. 1C and 1D descriptions. The toiletries dispensing device 100 also includes a back plate 150 that supports a non-evasive means for mounting the toiletries dispensing device 100 to a wall or other vertical surface (not shown) that is well known in the art. A bottom support surface 160 with a smooth surfacing 162 that can any dispensing bottles 112 can be set onto is also attached to the bottom of the back plate 152. The back plate 150 can be mounted without damage to any vertical mounting surface by utilizing double sided tape (See FIG. 1C description) or other non-evasive means for mounting the toiletries dispensing device 100. The flange assembly 130 also has a top surface 132 that the pumps 120 extend above with enough room to depress the pumps 120 to comfortably dispense any toiletries (not shown) from the dispensing bottles 110.

FIG. 1B illustrates a tilted front side perspective view of a toiletries dispensing device 100 without dispensing bottles 110, in accordance with one embodiment of the present invention. FIG. 1C illustrates a rear side perspective view of a toiletries dispensing device 100 without dispensing bottles 110, in accordance with one embodiment of the present invention. FIG. 1D illustrates an exploded overhead perspective view of a flange assembly 130 of the toiletries dispensing device 100 without dispensing bottles 110, in accordance with one embodiment of the present invention.

The toiletries dispensing device 100 can be used without any included dispensing bottles 110, since any dispensing bottles 110 that are well known in the art can be used with the toiletries dispensing device 100 that can fit on the bottom support surface 160. The flange assembly 130 of the toiletries dispensing device 100 also has a plurality of pump apertures 134 to accommodate the pumps 120 from the dispensing bottles 110. The number of pump apertures 134 is always equal to or greater than the number of dispensing bottles 110, although typically a user will utilizes as many dispensing bottles 110 as possible that the number of pump apertures 134 will accommodate. There is also a plurality of mounting apertures 170 that are disposed on the back plate 150 to accommodate any protruding screws, bolts, hooks or other protruding fastening non-evasive means for mounting the toiletries dispensing device 100 already existing on a wall or other vertical surface. Any number of mounting apertures 170 that are disposed anywhere on the back plate 150 that are well known in the art can be utilized.

FIG. 1C also illustrates two receiving slots 180 that can receive two corresponding and aligned attachment tabs 190 from a removable section 136 of the flange assembly 130 that are removably attached to the stationary section of the flange assembly 138 to form the flange assembly 130 as described in the FIG. 1D description. Any number of receiving slots 180 and attachment tabs 190 that are well known in the art can be used to form the flange assembly 130. The stationary section of the flange assembly 138 is permanently disposed on the top of the back plate 154 and forms the pump apertures 134 on the flange assembly 130. The two sided tape 156, previously mentioned in the FIG. 1A description, can be disposed anywhere as desired on the back plate 150 in any length or orientation to mount the toiletries dispensing device 100 to a wall or any vertical surface. The two sided tape 156 can also be utilized together with the mounting apertures 170 to mount the toiletries dispensing device 100 to a wall or any vertical surface.

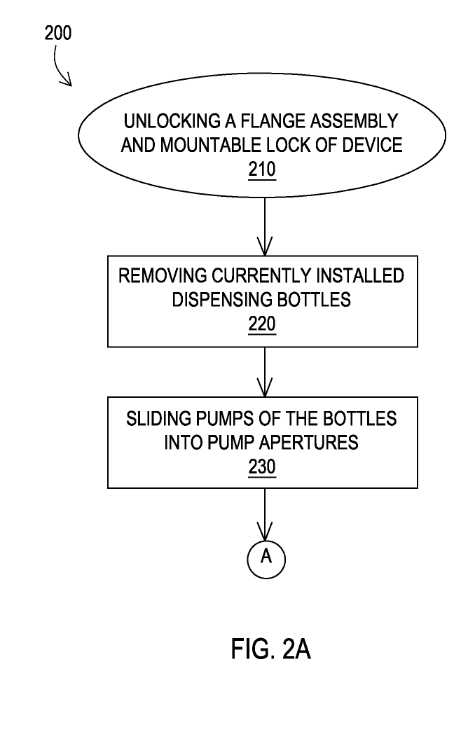

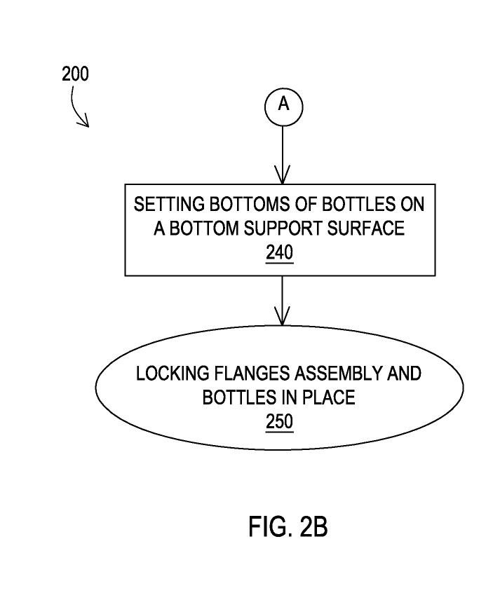

FIGS. 2A and 2B illustrate a flow chart of a method for replacing dispensing bottles in a toiletries dispensing device 200, in accordance with one embodiment of the present invention. The steps of the method for replacing dispensing bottles in a toiletries dispensing device 200 include unlocking a flange assembly and a mountable lock of the device 210, removing the currently installed dispensing bottles 220, sliding pumps of the new dispensing bottles into pump apertures 230, setting a bottom of the dispensing bottles on a bottom support surface 240 and locking the flange assembly and dispensing bottles in place 250. The toiletries dispensing device and dispensing bottles have the same components and features as described in the FIGS. 1A, 1B, 1C and 1D descriptions.

Each dispensing bottle has a pump that extends through a flange assembly and a mountable lock. The mountable lock keeps the dispensing bottles in place while allowing only authorized person's access to the dispensing bottles. A pin stud is provided for each dispensing bottle and secures each dispensing bottle by mating with a pin stub aperture disposed on the back plate forming a secure attachment of the removable section of the flange assembly with the stationary section of the flange assembly. The toiletries dispensing device also includes a back plate that supports a non-evasive means for mounting the toiletries dispensing device to a wall or other vertical surface (not shown) that is well known in the art. A bottom support surface which has a smooth surfacing that can accommodate the bottoms of any dispensing bottles is also attached to the bottom of the back plate. The back plate can be mounted without damage to any vertical mounting surface by utilizing double sided tape or other non-evasive means for mounting the toiletries dispensing device. The flange assembly and mountable lock is attached to the top of the back plate. The flange assembly also has a top surface where the pump sections extend above with enough room to depress the pump to comfortably dispense any toiletries (not shown) from the dispensing bottles.

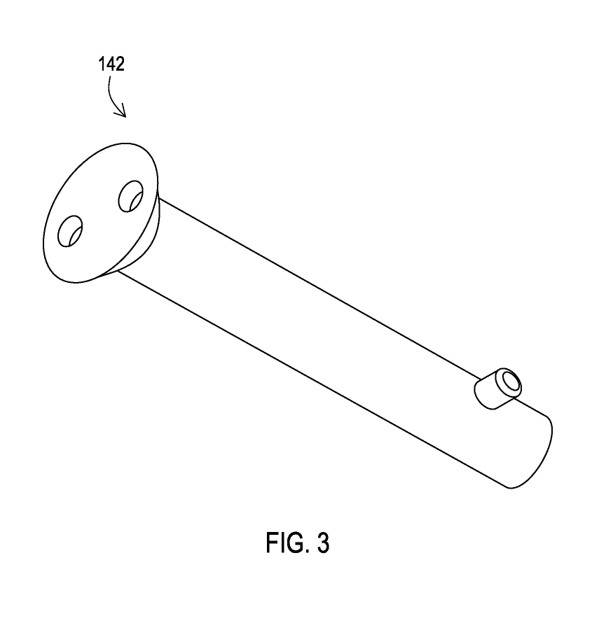

FIG. 3 shows a pin stud 142, in accordance with one embodiment of the present invention.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A toiletries dispensing device, comprising;
a back plate with a top and a bottom that supports a non-evasive means for mounting said toiletries dispensing device on a wall or other vertical mounting surface;
a plurality of dispensing bottles with a top and a bottom on each said dispensing bottle and a pump disposed on said top of each said dispensing bottle to dispense toiletries as desired by a user;
a flange assembly with a top surface, a removable section with a plurality of attachment tabs, a stationary section with a plurality of receiving slots and a plurality of pump apertures that hold and secure said dispensing bottles, said receiving slots and said attachment tabs are correspondingly aligned, removably attached and form said flange assembly;
a mountable lock integral to said removable section disposed on top of said toiletries dispensing device to keep said dispensing bottles in place while allowing only authorized persons access to said dispensing bottles; and
a bottom support surface that hold said dispensing bottles that is also attached to said bottom of said back plate.

2. The device according to claim 1, wherein said non-evasive means for mounting is double-sided tape or a plurality of mounting apertures.

3. The device according to claim 2, wherein said non-evasive means for mounting is said double-sided tape and said plurality of mounting apertures.

4. The device according to claim 3, wherein said mounting apertures accommodate any protruding screws, bolts, hooks or other protruding fasteners already existing on said wall or other vertical mounting surface.

5. The device according to claim 1, wherein said mountable lock is a pin stud.

6. The device according to claim 5, wherein said pin stud mates and engages with a pin stud aperture disposed on said back plate to lock said flange assembly.

7. A toiletries dispensing device to accommodate a plurality of dispensing bottles, comprising:
a back plate with a top and a bottom that supports a non-evasive, means for mounting said toiletries dispensing device on a wall or other vertical mounting surface;
a plurality of dispensing bottles with a top and a bottom on each said dispensing bathe and a pump disposed on said top of each said dispensing bottle to dispense toiletries as desired by a user;
a flange assembly with a top surface, a removable section with a plurality of attachment tabs, a stationary section with a plurality of receiving slots and a plurality of pump apertures that hold and secure said dispensing bottles, said receiving slots and said attachment tabs are correspondingly aligned, removably attached and form said flange assembly;
a mountable, lock integral to said removable section disposed on top of said toiletries dispensing device to keep said dispensing bottles in place while allowing only authorized persons access to said dispensing bottles; and
a bottom support surface that hold said dispensing bottles that is also attached to said bottom of said back plate.

8. The device according to claim 7, wherein said non-evasive means for mounting is double-sided tape or a plurality of mounting apertures.

9. The device according to claim 8, wherein said non-evasive means for mounting is said double-sided tape and said plurality of mounting apertures.

10. The device according to claim 9, wherein said mounting apertures accommodate any protruding screws, bolts, hooks or other protruding fasteners already existing on said wall or other vertical mounting surface.

11. The device according to claim 7, wherein said mountable lock is a pin stud.

12. The device according to claim 11, wherein said pin stud mates and engages with a pin stud aperture disposed on said back plate to lock said flange assembly.

13. A method for replacing dispensing bottles in a toiletries dispensing device, comprising the steps of:
unlocking a flange assembly and a mountable lock of said device;
removing currently installed said dispensing bottles;
sliding pumps of new said dispensing bottles into pump apertures;
setting said dispensing bottles on a bottom support surface; and
locking said flange assembly and said new dispensing bottles in place.

14. The method according to claim 13, wherein a non-evasive means for mounting said device to a vertical mounting surface is utilized.

15. The method according to claim 14, wherein said non-evasive means for mounting is double-sided tape or a plurality of mounting apertures.

16. The method according to claim 15, wherein said non-evasive means for mounting is said double-sided tape and said plurality of mounting apertures.

17. The method according to claim 16, wherein said mounting apertures accommodate any protruding screws, bolts, hooks or other protruding fasteners on said wall or other vertical mounting surface.

18. The method according to claim 13, wherein said mountable lock is a pin stud.

19. The method according to claim 18, wherein said pin stud mates and engages with a pin stud aperture disposed on said back plate to lock said flange assembly.

20. The method according to claim 13, wherein said pump apertures are disposed on said flange assembly.
